(19) United States
(12) Patent Application Publication
(10) Pub. No.: US 2015/0274584 A1
(43) Pub. Date: Oct. 1, 2015

(54) LAMINATED GLASS FOR USE IN VEHICLES OR IN ARCHITECTURE

(71) Applicant: Southwall Technologies Inc., Palo Alto, CA (US)

(72) Inventors: Ronny Kleinhempel, Gelenau (DE); Andre Karl-Heinz Wahl, Grossroehrdorf (DE); Roland Claus Thielsch, Dresden (DE)

(73) Assignee: SOUTHWALL TECHNOLOGIES INC., Palo Alto, CA (US)

(21) Appl. No.: 14/350,628

(22) PCT Filed: Dec. 13, 2012
(86) PCT No.: PCT/DE2012/001206

§ 371 Date: Apr. 9, 2014

(30) Foreign Application Priority Data
Dec. 15, 2011 (DE) 20 2011 109 312.7

(51) Int. Cl. C03C 17/36; C03C 17/42; B32B 17/06; C03C 17/245; C03C 17/38

(52) U.S. Cl. CPC C03C 17/3644; C03C 17/245; C03C 17/38; B32B 17/06; C03C 17/366; C03C 17/42; B32B 2605/006

(57) ABSTRACT

The invention relates to an laminated glass for use in vehicles or in architecture, having a selective reflection of electromagnetic radiation from the wavelength spectrum of sunlight. According to the invention, an optical multi-layer system having a total solar transmission of T_{TS}<40%, a transmission Tᵥᵢₛ in the wavelength range of visible light >70% and a reflection Rᵥᵢₛ in the wavelength range of visible light <12% is present on said laminated glass. For reflection upon vertical light incidence, it has a reflection colour according to ASTM 308 (illumination source D65 and standard observer 10°) within a colour space that is limited by the values Ra* from −5 to 5 and Rb* from −25 to −40. Alone or in addition, the laminated glass has a reflection colour according to ASTM 308 for transmission and reflection upon verticle light incidence within a colour space (colour box) that is limited by the values Ra* from −5 to 5 and Rb* from −25 to −40.

The invention relates to a laminated glass for use in vehicles or in architecture, having a selective reflection of electromagnetic radiation from the wavelength spectrum of sunlight. Multilayer systems that are partially optically transparent are used for this purpose.

Multilayer systems of this type are used for selectively influencing the transmission and reflection of electromagnetic radiation that is emitted by the sun, and in this application are formed as thin films by known vacuum coating methods, in particular PVD methods, on substrates, in particular glass or polymer films, which are transparent to electromagnetic radiation. The goal in this is to reflect the highest possible percentage of radiation in the non-visible range (e.g. the solar energy range, or the near infrared spectral range), thereby minimizing the percentage of solar energy that is transmitted. A particular goal is to limit the value of total solar transmission T_{TS} (calculated according to DIN ISO 13837, case 1) that is allowed to pass through a laminated glass equipped with a multilayer system of this type on said substrate to a maximum of 40% of the electromagnetic radiation that is emitted by the sun and reaches the earth's surface. The goal of this is to minimize the heating of the interior of rooms or vehicles and to reduce the amount of energy required to generate a climate that is comfortable to persons inside said rooms or vehicles. In contrast to this, however, the goal is further to prevent the reflection and to the greatest possible extent the absorption of the highest possible percentage of radiation in the visible light range, so that the portion of sunlight that is visible to the human eye (Tᵥᵢₛ, calculated according to ASTM E 308 for illumination source A and observer 2°, Rᵥᵢₛ is calculated according to the same standard where applicable) can be kept above 70%. This Tᵥᵢₛ standard is required by law for glass that will be used as vehicle glass.

Multilayer systems formed on substrates (glass or plastic) have long been used for this purpose. Said systems can be alternating layer systems in which high- and low-refraction layers of dielectric materials are formed one on top of the other.

Frequently, thin metal layers alternating with thin dielectric layers (oxides and nitrides) are also used. These oxides or nitrides require optical refraction indices ranging from 1.8 to 2.5 at a wavelength of 550 nm.

In addition to other reflective metals such as gold or copper, silver or silver alloys (Ag—Au, Ag—Cu, Ag—Pd and others) that have very beneficial optical properties for these applications are preferably used as the metal layers.

Aside from influencing the selective transmission and reflection of the electromagnetic radiation emitted by the sun, glass that is used in vehicles or in architecture also has an aesthetic requirement that relates to its visual color impression. For instance, conventional optical multilayer systems have a color impression under reflection that is neutral or is not predominantly green or blue. Frequently, however, it is desirable to achieve a different color impression that is adapted to the overall appearance of a vehicle or building.

The object of the invention is therefore to provide a laminated glass for use in vehicles or in architecture which has an intensive blue color impression and achieves a T_{TS} of <40% and preferably has a high visual transmission Tᵥᵢₛ of >70%.

According to the invention, this object is attained with a laminated glass having the features of claim 1. Advantageous embodiments and further developments can be implemented with the features specified in the dependent claims.

The laminated glass according to the invention has an optical multilayer system with which a total solar transmission T_{TS} of <40%, a transmission Tᵥᵢₛ in the visible light wavelength range of >70%, and a reflection in the visible light wavelength range Rᵥᵢₛ of <12% are achieved. The optical multilayer system can be formed directly on a glass surface or on an optically transparent polymer film or some other suitable substrate material. The coated polymer film or a substrate material can be attached flat to a glass surface using an adhesion promoter or an adhesion promoting film, or can be enclosed between two panes of glass, which are thereby bonded to one another.

The transmission of energy, for example, the total solar transmission T_{TS}, is determined according to ISO 13837.

In addition, for transmission and reflection upon vertical light incidence, the laminated glass has a reflection color according to ASTM 308 within a color space (color box) that is limited by the values Ra* of −5 to 5 and Rb* of −25 to −40, with the reflection color being determined with illumination source D65 and standard observer 10°.

Alone or in addition, with a light incidence angle of 60°, the reflection color can also lie within a color space (color box) that is limited by the values Ra* of 0 to 12 and Rb* of −20 to −30, with the reflection color being determined with illumination source D65 and standard observer 10°.

A spectral photometer, preferably with an integrating sphere, as is available from Perkin Elmer under model designation PE900, for example, can be used to determine the reflection color.

Upon vertical light incidence, the reflection color can lie within a smaller color space about an intensity center Ra*=0, Rb*=−35 within the color space(s) within a range of ±5, preferably ±2 for each of the values for Ra* and Rb*.

With a light incidence angle of 60°, the values for the reflection color about an intensity center of Ra*=7, Rb*=−25 can lie within the color space(s) within a range of ±5, preferably ±2 for each of the values for Ra* and Rb*.

The size of the color spaces is determined by production-based fluctuations in layer thickness (typically ±2% of the respective target layer thickness), which influence the precise color impression.

An optical multilayer system for the selective reflection of electromagnetic radiation from the wavelength spectrum of sunlight can be formed from at least one layer of silver—or a silver alloy—and at least one dielectric layer. A silver layer or a layer formed from a silver alloy can have a layer thickness ranging from 5 nm to 25 nm, and a dielectric layer can have a layer thickness ranging from 5 nm to 150 nm.

It is advantageous for a silver layer or a layer formed from a silver alloy to be coated with a “seed layer” and a “cap layer” over the entire area of both surfaces.

In addition to pure silver, a silver alloy containing small quantities of Au, Pd or Cu can also be used. In the following, such layers are generally referred to as silver layers. In the case of silver alloys, the percentage of other metals that are contained should be very small, if possible less than 2%.

An optical multilayer system or a plurality of these multilayer systems may be formed one on top of the other on the glass surface or polymer surface. In this case, conventional vacuum coating methods, particularly PVD methods and particularly advantageously magnetron sputtering may be used.

Mixed oxides ZnO:X with X being Al₂O₃, Ga₂O₃, SnO₂, In₂O₃ or MgO, for example, may be used to form the seed and cap layers. The seed layer and/or the cap layer should have a layer thickness ranging from 5 nm to 15 nm, and the silver layer should have a layer thickness between 5 nm and 25 nm, preferably 10 nm.

The cap layer can also consist of a thin metal layer—a so-called blocker layer, with blocker layers typically being made of Ti, NiCr and Cu and having layer thicknesses of <5 nm.

It is advantageously possible to produce additional dielectric layers that enclose such a multilayer system on both sides.

To produce an optical multi silver layer system, two or more single silver layer systems, preferably three single silver layer systems, can be deposited in a series of coating steps. A single silver layer system can be a structure comprising a dielectric layer, a thin seed layer, a silver layer, a cap layer and a final dielectric layer.

The thicknesses of the silver layers and the thicknesses of the dielectric layers should be adjusted to achieve the desired optical properties.

The dielectric layers that are present in multilayer systems of this type generally have a refraction index of n>1.8 at a wavelength of 550 nm and a lower absorption, and can be made, for example, of In₂O₃.

A dielectric layer structure formed between two silver layers and composed of cap layer, dielectric layer and seed layer acts as a dielectric spacer layer in an optical filter system for defining the position of the spectral transmission range and the color impression of a laminated glass. The use of dielectric materials for the seed layer and the cap layer is advantageous because the thicknesses of the seed layer and cap layer contribute to the layer thickness of dielectric spacer layers and thus produce an optical effect similar to that of other dielectric materials, thereby contributing to the overall optical effect.

Thus with a multilayer system construction having three silver layers each enclosed by a seed layer and a cap layer and dielectric layers on a PET film as the substrate, and with the use of a film coated in this manner in a laminated glass, an overall percentage of transmitted radiation T_{TS} of <40%, a percentage of transmitted radiation within the visible light wavelength spectrum Tᵥᵢₛ of >70%, and a percentage of reflected radiation in the visible light wavelength spectrum Rᵥᵢₛ of <10% could be maintained.

Additional options and suggestions for the production and parameters of optical multilayer systems as can be used according to the invention may also be found in the not previously published DE 10 2011 116 191, the entire disclosure of which is referenced here.

In the following, the invention will be specified in greater detail by way of example.

In this:

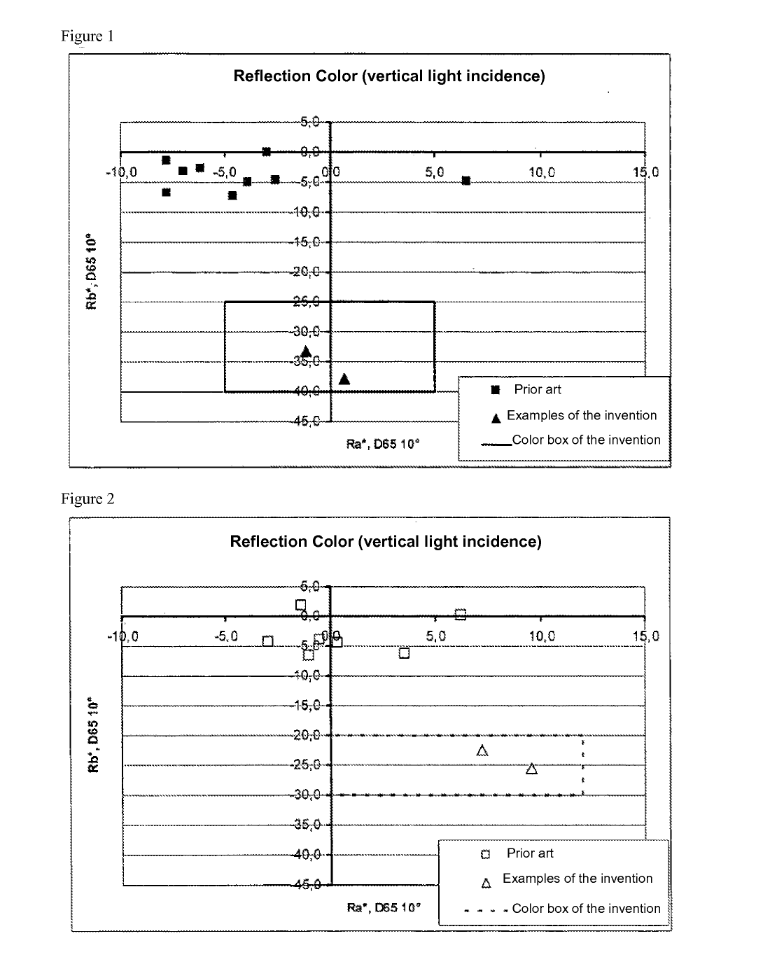

FIG. 1 shows a graph illustrating reflection colors within color spaces upon vertical light incidence;

FIG. 2 shows a graph illustrating reflection colors within color spaces upon light incidence at an angle of 60°;

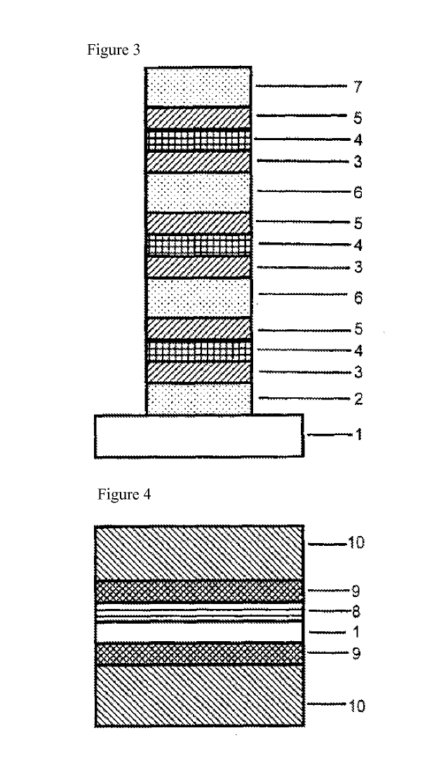

FIG. 3 shows an example in schematic form, in which three silver layers are provided, each with a seed layer and a cap layer, in a multilayer system construction; and

FIG. 4 shows a schematic illustration of the assembly of a multilayer system according to the invention with plastic film embedded in a laminated glass.

The graph shown in FIG. 1 indicates reflection colors within color spaces upon vertical light incidence. The individual values for the reflection colors have been determined as described in the general part of the description. According to the prior art, a color space for the values Ra* of 0 to −5 and for the values Rb* of −8 to −4 is preferred. Specifically achieved values are marked with ▪. As is clear from the graph, all of these values lie within the greenish color range with only one example of a value in the reddish range. The color coordinates shown were determined using commercially available laminated glasses (motor vehicle windshields). They represent the prior art and all have a TTS >40% (>45%).

The color space that is to be maintained according to the invention is shown at the bottom of the graph and characterizes the deep blue reflection color. Two specific values are marked with ▴ and have been determined using laminated glasses according to the invention (for an embodiment example, see below).

In the graph shown in FIG. 2, corresponding color spaces and values for a light incidence under 60° and a radiation source D65 are plotted. The specific values according to the prior art are marked with □, and values for reflection colors according to the invention are marked with Δ.

The multilayer system construction shown in FIG. 3 and comprising three silver layers 4, each of which is formed between a seed layer 3 and a cap layer 5, has been produced in three coating steps on a PET substrate 1.

Thus the dielectric layer 2 of In₂O₃ formed on the substrate 1 should have a layer thickness of 20 nm to 50 nm, and the dielectric layers 6 of In₂O₃, which are formed between a cap layer 5 and a seed layer 3, should have a thickness ranging from 40 nm to 150 nm. The dielectric layer 7 of In₂O₃, which is formed on the outer surface that faces away from the substrate 1, should have a thickness ranging from 20 nm to 70 nm. All the silver layers should have a layer thickness ranging from 7 nm to 25 nm.

Additionally, the multilayer system consisting of three multilayer systems according to the invention and formed one above the other can be optimized by adjusting individual layer thicknesses so as to achieve the properties T_{TS}<40%, Tᵥᵢₛ >70% and Rᵥᵢₛ<10% in a laminated glass. The structure of the “laminated glass” is illustrated in FIG. 4. In this diagram, 1 is a PET substrate, 8 is a multilayer system according to the invention having three silver layers, 9 is PVB (polyvinyl butyral) layers and 10 is glass.

In the example shown in FIG. 3, the layer thicknesses of the seed layers were kept to 3 to 8 nm and the thicknesses of the cap layers were kept to 5 to 7 nm. The silver layers 4 had the following thicknesses (starting from substrate 1): first silver layer=8.7 nm, second silver layer=16.9 nm and third silver layer=13.7 nm. The dielectric layers were produced from In₂O₃ and had the following thicknesses, likewise starting from substrate 1: 1st layer 2 of In₂O₃=24 nm, 2^{nd} layer 6 of In₂O₃=76 nm, 3^{rd} layer 6 of In₂O₃=90 nm and 4^{th} layer 7 of In₂O₃=32 nm.

With this layer system, the following values for the “laminated glass” were achieved:

### Tᵥᵢₛ (A, 2°)=72.4%

### Rᵥᵢₛ (A, 2°)=9.1%

### T_{TS} (ISO)=38.1%

Ra* (D65, 10°) vertical=0.7
Rb* (D65, 10°) vertical=−38.0
Ra* (D65, 10°) light incidence 60°=9.5
Rb* (D65, 10°) light incidence 60°=−25.5

1. A laminated glass for use in vehicles or in architecture, said laminated glass comprising an optical multilayer system and characterized by a total solar transmission T_{TS} of <40%, a transmission Tᵥᵢₛ in the visible light wavelength range of >70%, a reflection in the visible light wavelength range a reflection Rᵥᵢₛ<12%, and a reflection color determined according to ASTM 308 (illumination source D65 and standard observer 10°) for reflection upon vertical light incidence within a color space that is limited by the values Ra* of −5 to 5 and Rb* of −25 to −40.

2. The laminated glass according to claim 1, characterized in that said reflection color lies within a smaller color space about an intensity center Ra*=0, Rb*=−35 within the color space(s), within a range of ±5 for each of the values for Ra and Rb*.

3. The laminated glass according to claim 13, characterized in that said reflection color lies within a smaller color space about an intensity center Ra*=7, Rb*=−25 within the color space(s), within a range of ±5 for each of the values for Ra and Rb*.

4. The laminated glass according to claim 1, characterized in that said optical multilayer system comprises at least one layer of silver or a silver alloy and at least one dielectric layer.

5. The laminated glass according to claim 4, characterized in that said layer of silver or a silver alloy has a layer thickness ranging from 5 nm to 25 nm and said dielectric layer has a layer thickness ranging from 5 nm to 150 nm.

6. The laminated glass according to claim 4, characterized in that said optical layer system comprises three silver layers that are separated from one another by dielectric spacer layers.

7. The laminated glass according to claim 1 wherein said optical multilayer system is formed directly on a glass surface.

8. The laminated glass according to claim 1 wherein said optical multilayer system is formed on an optically transparent polymer film.

9. The laminated glass according to claim 4 wherein said optical multilayer system is formed directly on a glass surface.

10. The laminated glass according to claim 4 wherein said optical multilayer system is formed on an optically transparent polymer film.

11. The laminated glass of claim 8 wherein said optically transparent polymer film is attached to a glass surface.

12. The laminated glass of claim 8 wherein said optically transparent polymer film is enclosed between two planes of glass.

13. A laminated glass for use in vehicles or in architecture, said laminated glass comprising an optical multilayer system and characterized by a total solar transmission T_{TS} of <40%, a transmission Tᵥᵢₛ in the visible light wavelength range of >70%, a reflection in the visible light wavelength range Rᵥᵢₛ<12%, and a reflection color determined according to ASTM 308 (illumination source D65 and standard observer 10°) for reflection upon a light incidence angle of 60° within a color space that is limited by the values Ra* of 0 to 12 and Rb* of −20 to −30.

14. The laminated glass according to claim 13, characterized in that said optical multilayer system comprises at least one layer of silver or a silver alloy and at least one dielectric layer.

15. The laminated glass according to claim 14, characterized in that said layer of silver or a silver alloy has a layer thickness ranging from 5 nm to 25 nm.

16. The laminated glass accordingly to claim 14 characterized in that said dielectric layer has a layer thickness ranging from 5 nm to 150 nm.

17. The laminated glass accordingly to claim 15 characterized in that said dielectric layer has a layer thickness ranging from 5 nm to 150 nm.

18. The laminated glass according to claim 4, characterized in that said layer of silver or silver alloy has a layer thickness ranging from 5 nm to 25 nm.

19. The laminated glass accordingly to claim 4 characterized in that said dielectric layer has a layer thickness ranging from 5 nm to 150 nm.

20. The laminated glass according to claim 14 wherein said optical multilayer system is formed on an optically transparent polymer film.
